(19) United States
(12) Patent Application Publication
(10) Pub. No.: US 2021/0141648 A1
(43) Pub. Date: May 13, 2021

(54) CONFIGURATION MANAGER DATA STRUCTURES

(71) Applicant: Hewlett-Packard Development Company, L.P., Spring, TX (US)

(72) Inventor: Irwan Halim, Spring, TX (US)

(73) Assignee: Hewlett-Packard Development Company, L.P., Spring, TX (US)

(21) Appl. No.: 17/043,785

(22) PCT Filed: Jul. 31, 2018
(86) PCT No.: PCT/US2018/044644

§ 371 Date: Sep. 30, 2020

(51) Int. Cl. G06F 9/445; H04L 12/24; G06F 16/901; G06F 16/28; G06F 9/4401

(52) U.S. Cl. CPC G06F 9/4451; H04L 41/085; G06F 9/4416; G06F 16/9024; G06F 16/285; H04L 41/0866

(57) ABSTRACT

An example service device may include a category manager engine to maintain a configuration manager data structure, a priority engine to cause arrangement of references in art order of category priority, and a configuration file request engine to provide access fo the configuration manager data structure. An example computer device may include a configuration requestor engine to retrieve settings parameters based on an order of priority of categories set by a configuration manager data structure and a configuration generator engine fo generate a settings configuration file based on the order of priority of categories.

### BACKGROUND

Computer devices, such as notebooks, desktops, and mobile devices, may communicate electronically over networks. Computer devices may be managed to provide services in an expected manner. For example, computer devices existing on the same network for a corporation may be expected to provide access to the same systems and program applications as other computer devices on the network. Some operating systems and program applications may have adjustable operational settings. Such settings may be stored on individual systems and/or stored at a centralized location, such as a server.

### BRIEF DESCRIPTION OF THE DRAWINGS

FIGS. 1A-1C are block diagrams depicting example computer systems.

FIG. 2 depicts an example environment in which various computer systems may be implemented.

FIGS. 3A and 38 are block diagrams depicting example computer systems.

FIGS. 4A-4D depict example data structures useable with example computer systems.

FIGS. 5 and 6 are flow diagrams depicting example methods of managing settings.

FIGS. 7 and 8 are flow diagrams depicting example methods of generating a configuration file.

### DETAILED DESCRIPTION

In the following description and figures, some example implementations of settings systems, computer devices, methods of managing settings, and/or methods of generating a configuration file are described. Computer systems may restrict customizations and/or limit settings capabilities. In other systems, data may not be saved between user sessions on a computer device. A settings manager may operate on a computer device to control settings of the computer device. The settings manager may monitor the system to maintain settings. The settings manager may request settings to be implemented on the computer device based on events, such as on boot or starting a new user session. The settings manager may request such settings from a centralized service that provides uniform and/or customized settings for each device of a network of devices.

Settings may be applied based on groups. For example, access may be restricted to a first set of users and allowed to a second, more privileged set of users. For another example, a network may include multiple domains where one domain may require access to a particular setting while the other domain may require the setting to be the same on all devices. In some systems, a fixed set of settings and priorities of those setting suggestions for each group may be used. However, conflicts over setting options may exists between groups. The settings manager may require instruction as to how to resolve such conflicts.

Various examples described below relate providing a configuration manager data structure that is dynamically adjustable to prioritize settings. By providing adjustability to priorities of sets of settings as suggested by different groups, a network manager may allow for different configurations based on changes to the groups. Indeed, a solution including a dynamically adjustable configuration manager data structure may allow for flexibility and mobility of settings to follow devices and users around the network and simplify information technology management regarding user and system configurations, as examples.

FIGS. 1A-1C are block diagrams depicting example computer systems 100 and 110. Referring to FIG. 1A, the example service device 100 of FIG. 1 generally includes a category manager engine 102, a priority engine 104, a configuration file request engine 106, and a configuration manager data structure 108. In general, the configuration file request engine 106 provides access to the configuration manager data structure 108 that is managed by the category manager engine 102 based on parameters supplied by the priority engine 104. As used herein, the configuration manager data structure 108 is a logical data organization and data storage format with relationships that represents an order of categories of settings. For example, the configuration manager data structure 108 may include a data element for each top-level category of settings and a parameter, function, or organization of the data elements that indicates an order of priority of the various top-level categories. The configuration manager data structure 108 may be adjustable via the category manager engine 102 and/or the priority engine 104, such that the priority of a category of settings may be changed relative to another category of settings, rather than a fixed global hierarchy of settings categories. The configuration manager data structure 108 may be stored in a computer-readable format on a storage medium accessible by a computer device to generate a settings configuration file for that computer device.

The category manager engine 102 represents any circuitry or combination of circuitry and executable instructions to maintain the configuration manager data structure 108 with a plurality of references in an order of category priority. For example, the category manager engine 102 may be a combination of circuitry and executable instructions that perform an operation to change the position of a reference when the priority identifier is different from a current position of the reference associated with the category identifier. As used herein, a priority identifier may be a value, character, symbol, or the like that represents a level of priority and a category identifier may be a value, character, symbol, or the like that represents a group of settings. Each reference of the configuration manager data structure 108 is directed to a category configuration file corresponding to a resource folder for a group of settings (i.e. a settings category). The category configuration file includes a number of settings and parameters corresponding to that settings category. A category configuration file may make reference to another configuration file and may refer to a location to retrieve resources, such as a resource folder. The configuration file may point to the next configuration file in any appropriate location. For example, each group may be on a different server, a different network storage, a different region, etc., and may include instructions on how to authenticate (e.g., metadata). The resource folder holds any kind of files that may be referenced in the configuration file.

The priority engine 104 represents any circuitry or combination of circuitry and executable instructions to cause the category manager engine 102 to arrange the plurality of references of the configuration manger data structure 108 in an order based on parameters, such as a category identifier representing a settings category and a priority identifier representing a degree of priority of that particular settings category with respect to other settings categories. In the example, of a linked list data structure, the priority engine 104 may instruct the category manager engine 102 with a priority for category and the category manager engine 102 rearranges the link pointers to place the link element corresponding to specified category to a position in the order of the references based on the priority identifier. In this manner, the order of category priority is changed by changing links between data elements of the linked list. In the example of a declared list, the priority engine 104 may instruct the category manager engine 102 to move a declaration line corresponding to a category to another position (e.g., another line number) based on the priority identifier with respect to that position.

The configuration file request engine 106 represents any circuitry or combination of circuitry and executable instructions to provide access to the configuration manager data structure 108 to cause generation of a settings file of configuration settings based on retrieval of resources from resource folders in the order of the plurality of references of the configuration manager data structure. Access to the configuration manager data structure 108 may be direct access to the values or may be indirect access via function calls of the configuration manager data structure 108, such as through an application programming interface (API). The retrieval of settings information (e.g., configuration files and resources) may happen in parallel or sequentially and processed in the order as configured in the settings file.

Referring to FIG. 16, the example computer device 110 of FIG. 1B generally includes a configuration requester engine 112 and a configuration generator engine 114. In general, the configuration requestor engine 112 requests setting information (e.g., via the configuration manager data structure 108 of the service device 100) and the configuration generator engine 114 generates a configuration file from the setting information and the configuration file is used by the computer device 110 to establish settings of the computer device 110.

The configuration requester engine 112 represents any circuitry or combination of circuitry and executable instructions to retrieve system information and retrieve settings parameters corresponding to the system information based on an order of priority of categories set by a configuration manager data structure describing a settings hierarchy. For example, the configuration requestor engine 112 may be a combination of circuitry and executable instructions that trigger a settings retrieval request based on a system event, such as identification of a service available on a network (e.g., a network event) or when a user logs in or out (e.g., a user session event), and retrieves system information of the computer device corresponding to a number of settings categories upon the identification (e.g., upon the network event). The configuration requestor engine 112 may track a subcategory level corresponding to a category configuration file (e.g., a corresponding reference in a sequence of pointers of the configuration manager data structure 108).

The configuration generator engine 114 represents any circuitry or combination of circuitry and executable instructions to generate a settings configuration file based on the order of priority of settings categories and retrieve settings resources corresponding to the configuration resources. For example, the configuration generator engine 114 may be a combination of circuitry and executable instructions that generate a settings configuration file based on a priority order represented by data relationships of a configuration manager data structure. The settings configuration file may be generated by the configuration generator engine 114 based on an order of retrieval of configuration resources or a priority identifier associated with each retrieval of configuration resources. For example, the configuration generator engine 114 may generate a configuration file by identifying settings that have duplicates and overwriting one of the duplicates of the corresponding configuration setting based on the priority order of the category from which the duplicate setting category was retrieved. The configuration generator engine 114 may perform a merger of settings of the category configuration file with previously retrieved setting when a previous setting existed. In an example where the category levels are tracked, the configuration generator engine 114 merges the settings of the category configuration file with a previously retrieved settings parameter when the subcategory level indicates a priority over a subcategory level of a previous category configuration file corresponding to the previously retrieved setting.

The configuration requestor engine 112 and the configuration generator engine 114 may operate based on the format of the configuration manager data structure representing the priority order of settings categories. For example, the final settings configurations file is built based on a sequence of pointers to configuration resources (e.g., via a configuration manager data structure in the form of a linked list). For another example, the configuration manager data structure may represent a hierarchy of setting priority and the configuration generator engine 114 may crawl the hierarchy to generate the final configuration the for a computer device. For example, the configuration generator engine 114 may check if the category of settings being retrieved is a subcategory, such as a substring of a domain name or a subnet, or a top level category, such as the top domain number), download the settings parameter from a settings data store corresponding to the subcategory or top-level category, merge the settings parameter into the configuration file when a previous setting existed, and continue to any further settings categories until there is no longer a subcategory to produce a final category setting resulting from the merger of categories.

The configuration generator engine 114 may cause the computer device to retrieve resources corresponding to the final settings of the final configuration file. For example, the configuration generator engine 114 may download settings resources corresponding to the configuration resources based on priority order (e.g., the order of retrieval of configuration resources or the priority identifier associated with each retrieval of configuration resources) and cause the computer device to download resources from a resource data store corresponding to the settings configuration file of the final category setting. A resource useable with configuration settings, as discussed herein, includes any appropriate electronic file type, such as text documents, pictures, videos, audio files, universal resource locators (URL), scripts, executable files, markup language files, registry files, libraries, drivers, data files, license files, compression files, and the like.

Referring to FIG. 1C, a settings system 190 may include a service device 100 and a computer device 110 coupleable with the service device 100 to retrieve settings from the service device 100 to establish settings on the computer devices 110 in an order based on the data relationships of the configuration data manager (CMDS) 108. Any number of computer devices 110 may be able to communicate with the service device 100 which provides setting information to the computer devices 110 based on their particular machine information. In some examples, functionalities described herein in relation to any of FIGS. 1-4 may be provided in combination with functionalities described herein in relation to any of FIGS. 5-8.

FIG. 2 depicts example environments 290 in which various example settings systems 200 may be implemented. The example environment 290 is shown to include an example system 200 for providing settings to a computer device 226. The system 200 (described herein with respect to FIGS. 1A-1C) may represent generally any circuitry or combination of circuitry and executable instructions to provide settings to a computer device. The system 200 may include a category manager engine 202, a priority engine 204, a configuration file request engine 206, a configuration requestor engine 212, and a configuration generator engine 214 that are the same as the category manager engine 102, the priority engine 104, the configuration file request engine 106, the configuration requester engine 112, and the configuration generator engine 114 of FIGS. 1A-1C, respectively, and the associated descriptions are not repeated for brevity. As shown in FIG. 2, the engines 202, 204, 206, 212, and 214 may be integrated into a computer device, such as a service device 224 or a user device 226. The engines 202, 204, 206, 212, and 214 may be integrated via circuitry or as installed instructions into a memory resource of the computer device.

The example environment 290 may include computer devices, such as manager devices 222, service devices 224, and user devices 226. A first set of settings may be developed, identified, and/or modified on a manager device 222. For example, a set of application and operating system settings and a priority for the settings may be identified on a manager device 222 and stored onto a web server, such as a service device 224. The service devices 224 represent generally any computer devices to respond to a network request received from a user device 226, whether virtual or real. For example, the service device 224 may operate a combination of circuitry and executable instructions to provide a network packet in response to a request for a page or functionality of an application. The user devices 226 represent generally any computer devices to communicate a network request and receive and/or process the corresponding responses. For example, a browser application may be installed on the user device 226 to receive the network packet from the service device 224 and utilize the payload of the packet to display an element of a page via the browser application.

The computer devices may be located on separate networks 220 or part of the same network 220. The example environment 290 may include any appropriate number of networks 220 and any number of the networks 220 may include a cloud compute environment. A cloud compute environment may include a virtual shared pool of compute resources. For example, networks 220 may be distributed networks comprising virtual computing resources. Any appropriate combination of the system 200 and computer devices may be a virtual instance of a resource of a virtual shared pool of resources. The engines and/or modules of the system 200 herein may reside and/or execute “on the cloud” (e.g., reside and/or execute on a virtual shared pool of resources). In this manner, the engines of the service device 100 of FIG. 1A may be offered as a cloud-based service. In some examples, the configuration requestor engine 212 and the configuration generator engine 214 may be offered as a cloud-based service that provides a final configuration file to a requesting user device 226.

A connection 228 generally represents one or a combination of a cable, wireless connection, fiber optic connection, or remote connections via a telecommunications link, an infrared link, a radio frequency link, or any other connectors of systems that provide electronic communication. The connection 228 may include, at least in part, intranet, the Internet, or a combination of both. The connection 228 may also include intermediate proxies, routers, switches, load balancers, and the like.

The data store 218 may contain information utilized by the engines 202, 204, 206, 212, and/or 214. For example, the data store 218 may store the configuration manager data structure 208, configuration files, and settings resources.

FIGS. 3A and 3B are block diagrams depicting example computer systems. FIGS. 3A and 3B depict the example systems 300 may comprise a memory resource 330 operatively coupled to a processor resource 332. The memory resource 330 may contain a set of instructions that are executable by the processor resource 332. The set of instructions are operable to cause the processor resource 332 to perform operations of the system 300 when the set of instructions are executed by the processor resource 332. Referring to FIG. 3A, the set of instructions stored on the memory resource 330 may be represented as a category manager module 202, a priority module 204, and a configuration file request module 206. The memory resource 330 may also store data, such as the configuration manager data structure 308. Referring to FIG. 3B, the set of instructions stored on the memory resource 330 may be represented as a configuration requestor module 312 and a configuration generator module 314. The category manager module 302, the priority module 304, the configuration file request module 306, the configuration requestor module 312, and the configuration generator module 314 represent program instructions that when executed cause function of the category manager engine 102, the priority engine 104, the configuration file request engine 106, the configuration requestor engine 112, and the configuration generator engine 114 of FIGS. 1A and 1B, respectively.

The processor resource 332 may carry out a set of instructions to execute the modules 302, 304, 306, 312, 314, and/or any other appropriate operations among and/or associated with the modules of the system 300. For example, the processor resource 332 may carry out a set of instructions to receive a priority order request regarding setting category priority for a configuration manager data structure, arrange a pointer of the configuration manager data structure to a data structure element based on a position identifier of the priority order request, and provide access by a computer device to the configuration manager data structure to retrieve settings via a category configuration file corresponding to the data structure element based on a pointer sequence of the configuration manager data structure. For another example, the processor resource 332 may carry out a set of instructions to rearrange pointer references corresponding to the order of relationships of categories of configuration settings of the configuration manager data structure based on parameters of a priority order update request. For yet another example, the processor resource 332 may carry out a set of instructions to retrieve machine information corresponding to a computer device, retrieve data of a configuration manager data structure having an order of relationships of categories of configuration settings, identify configuration information corresponding to the machine information based on the order of relationships of the configuration manager data structure, generate the configuration file with configurations settings based on the order of relationships of the configuration manager data structure, and establish settings of the computer device based on the generated configuration file.

Although these particular modules and various other modules are illustrated and discussed in relation to FIGS. 3A-B and other example implementations, other combinations or sub-combinations of modules may be included within other implementations. Said differently, although the modules illustrated in FIGS. 3A-B and discussed in other example implementations perform specific functionalities in the examples discussed herein, these and other functionalities may be accomplished, implemented, or realized, at different modules or at combinations of modules. For example, two or more modules illustrated and/or discussed as separate may be combined into a module that performs the functionalities discussed in relation to the two modules. As another example, functionalities performed at one module as discussed in relation to these examples may be performed at a different module or different modules.

A processor resource is any appropriate circuitry capable of processing (e.g., computing) instructions, such as one or multiple processing elements capable of retrieving instructions from a memory resource and executing those instructions. For example, the processor resource 332 may be a central processing unit (CPU) that enables providing settings to a computer device by fetching, decoding, and executing modules 302, 304, 306, 312, and/or 314. Example processor resources include at least one CPU, a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). A processor resource may include multiple processing elements that are integrated in a single device or distributed across devices. A processor resource may process the instructions serially, concurrently, or in partial concurrence.

A memory resource (including data store 218 of FIG. 2) represents a medium to store data utilized and/or produced by the system 300. The medium is any non-transitory medium or combination of non-transitory media able to electronically store data, such as modules of the system 300 and/or data used by the system 300. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. A memory resource may be said to store program instructions, that when executed, by a processor resource cause the processor resource to implement functionality of the system 300 of FIG. 3. A memory resource may be integrated in the same device as a processor resource or it may be separate but accessible to that device and the processor resource. A memory resource may be distributed across devices.

In the discussion herein, the engines 102, 104, 106, 108, 112, and 114 of FIGS. 1A-1C; the engines 202, 204, 206, 212, and 214 of FIG. 2; and the modules 302, 304, 306, 312, and 314 of FIGS. 3A and 3B have been described as circuitry or a combination of circuitry and executable instructions. Such components may be implemented in a number of fashions. Looking at FIGS. 3A and 3B, the executable instructions may be processor-executable instructions, such as program instructions, stored on the memory resource 330, which is a tangible, non-transitory computer-readable storage medium, and the circuitry may be electronic circuitry, such as processor resource 332, for executing those instructions. The instructions residing on a memory resource may comprise any set of instructions to be executed directly (such as machine code) or indirectly (such as a script) by a processor resource.

In some examples, the system 300 may include the executable instructions may be part of an installation package that when installed may be executed by a processor resource to perform operations of the system 300, such as methods described with regards to FIGS. 5-8. In that example, a memory resource may be a portable medium such as a compact disc, a digital video disc, a flash drive, or memory maintained by a computer device, such as a service device 224 of FIG. 2, from which the installation package may be downloaded and installed. In another example, the executable instructions may be part of an application or applications already installed. A memory resource may be a non-volatile memory resource such as read-only memory (ROM), a volatile memory resource such as random-access memory (RAM), a storage device, or a combination thereof. Example forms of a memory resource include static RAM (SRAM), dynamic RAM (DRAM), electrically erasable programmable ROM (EEPROM), flash memory, or the like. A memory resource may include integrated memory such as a hard drive (HD), a solid-state drive (SSD), or an optical drive.

Referring to FIGS. 1A-3B, the engines 102, 104, 106, 112, and 114 of FIGS. 1A-1C; the engines 202, 204, 206, 212, and 214 of FIG. 2; and/or the modules 302, 304, 306, 312, and 314 of FIG. 3A-3B may be distributed across devices 222, 224, and 226 of FIG. 2, or a combination thereof. The engine and/or modules may complete or assist completion of operations performed in describing another engine and/or module. For example, the category manager engine 202 of FIG. 2 may request, complete, or perform the methods or operations described with the category manager engine 102 of FIG. 1A as well as the priority engine 104 and the configuration file request engine 106 of FIG. 1A. Thus, although the various engines and modules are shown as separate engines in FIGS. 1A-3B, in other implementations, the functionality of multiple engines and/or modules may be implemented as a single engine and/or module or divided in a variety of engines and/or modules. In some example, the engines of the system 300 may perform example methods described in connection with FIGS. 5-8.

FIGS. 4A-4D depict example data structures useable with example computer systems. The example data structures of FIGS. 4A-4D may be stored on a memory resource coupled to a computer device, such as server device. Referring to FIG. 4A, the example configuration manager data structure 408 is a linked list having a number of links 440, 450, 460, and 470. Each link represents a settings category (e.g., a top-level settings category). Each link includes a configuration file (e.g., 442, 452, 462, 472), a resource folder location (e.g., 444, 454, 464, and 474), and a pointer (e.g., 446, 456, 466, and 476). The resource folder location may make reference to a relative folder path on a server or may make reference to a URL with a destination storing the resource, as examples. The pointer includes a destination to another link and the order of priority of the settings categories is set based on the sequence order of the pointers through the linked list. In this manner, each category link includes a next setting item that points to the next category of priority until the end of the list is reached. In other examples of configuration manager data structures, each link may include a priority order identifier corresponding to the category's position in the priority hierarchy of settings categories.

Referring to FIG. 4B, a configuration file 480 may include a group of setting categories (e.g., 481 and 485) that include one or more setting items (e.g., 482, 483, 484, 486, 487 and 488). The configuration file 480 may include any number of setting categories (such as display settings, power management settings, security settings, privacy settings, network settings, etc.) and each setting category may have any number of setting items corresponding to that type of settings. For example, a display setting may include a resolution attribute, an orientation attribute, a position attribute, a contrast attribute, a brightness attribute, a color calibration attribute, a background picture, etc. As shown in FIG. 4C, an example setting item 490 may include metadata 492, setting attributes 494, and/or a resource location 496. Metadata 492 may be any appropriate data value, character, string, classification, symbol, etc. that represents data about the setting item 490, such instructions regarding implementing the setting. Setting attributes may be any appropriate data value, character, string, classification, symbol, etc. that represents a property of the setting, such as a degree, amount, selection, color, etc. of the setting. A resource location 496 may be any appropriate data value, character, string, classification, symbol, etc. that represents a location to discover a resource corresponding to the setting item.

Referring to FIG. 4D, an example settings hierarchy 498 may include a number of top-level categories of settings. In the example of FIG. 4D, the top-level categories include, from lowest priority to highest priority, a global category, a subnets category, a domains category, a media access control (MAC) address category, and a users category. In this example, the settings may be retrieved from top to bottom, where the later retrieved settings override any of the previous settings if there is a conflict. In other examples, the order of categories may be different, the number of categories may be different, and/or the settings may be retrieved in a different manner that allows for dynamic prioritization of groups of settings categories.

Each category includes a configuration file (referenced as “CONFIG.XML” in FIG. 4D) and a resources locator (referenced as “RESOURCE” in FIG. 4D). The configuration file may be in any appropriate data format, such as formatted in extensible markup language or common initialization file formats including files with extensions .INI, .CONFIG, .CFG, .TXT, .SYS, and the like. Some categories link to a subcategory. For example, the subnet category that may have subcategory representing a substring mask such that various subnets may receive particular settings different from other subnets. The more particular subnets may have a higher priority of setting than the more general subnets. The resources locator links to particular resources used with that setting, such as a picture to use as a wallpaper background.

FIGS. 5 and 6 are flow diagrams depicting example methods of managing settings. Referring to FIG. 5, example methods of managing settings may generally comprise receiving a priority order request, arranging a pointer of the configuration manager data structure based on a position identifier of the priority order request, and provide access to data values of the configuration manager data structure to retrieve settings. The methods of FIGS. 5 and 6 are performable by a category manager engine, a priority engine, and/or a configuration file request engine, such as engines 102, 104, and 106 of FIG. 1A.

At block 502 of FIG. 5, a priority order request is received regarding setting category priority for a configuration manager data structure, such as a configuration manager data structure representing a hierarchy of configuration settings. The configuration data structure may be linked list with data structure elements (e.g., links) including pointers to subsequent elements of the list. At block 504, a painter of the configuration manager data structure is arranged to a data structure element based on a position identifier of the priority order request. At block 506, access is provided to a computer device to retrieve settings via a configuration file of the configuration manager data structure based on a pointer sequence of the configuration manager data structure. In this manner, the linked list can be walked along, retrieving configuration files and setting information from each element of the linked list, by following the sequence of pointers to each link of linked list. The result of that example, may be retrieval of a number of settings in an order based on the relationship of links of the configuration manager data structure.

FIG. 6 includes blocks similar to blocks of FIG. 5 and provides additional blocks and details. In particular, FIG. 6 depicts additional blocks and details generally regarding rearranging pointer references, identifying an initial category and category order, and setting a location of the pointer reference to maintain a priority order of the configuration manager data structure. Blocks 602 and 612 are the same as blocks 502 and 506 of FIG. 5 and, for brevity, their respective descriptions are not repeated.

At block 604, pointer references are rearranged in correspondence with, the order of relationships of categories of the configuration settings of the configuration manager data structure based on the parameters of the priority order request in response to parameters indicating a change to the priority order of the settings categories. The priority order request may be made by a manager via a manager device, such as manager device 222 of FIG. 2, to change the priority order of a top-level category with respect to another top-level category. Other examples of changing the priority order may be increasing priority of a top-level category, decreasing a priority of a top-level category, adding a top-level category, deleting a top-level category, changing a subcategory to a top-level category, changing a top-level category to a subcategory, and the like.

At block 606, an initial category may be identified based on the request parameters of block 604 and the previous relationships of the elements of the configuration manager data structure. For example, a request to decrease the priority of a settings category may involve moving that setting category to the lowest priority and, therefore, may be retrieved before other settings to be overwritten by later conflicts by higher priority settings categories. In that example, the link corresponding to that lowest priority setting category may be set to the initial link in the linked list. At block 608, a category order is identified based on the priority order request. The category order may be identified based on a parameter of the request and/or the previous relationships between elements of the configuration manager data structure. At block 610, a location of a pointer reference is set to an element based on the identified category order. For example, the relationships between links of the configuration manager may be arranged to place the links in the appropriate order represented by the priority order update request. At block 612, the configuration manager data structure is updated with reference to the initial category element and access is provided to the configuration manager data structure to a computer device requesting a settings configuration file corresponding to the configuration manager data structure.

FIGS. 7 and 8 are flow diagrams depicting example methods of generating a configuration file. Referring to FIG. 5, example methods of managing settings may generally comprise retrieving machine information, retrieving data of a configuration manager data structure, identifying configuration information, generating a configuration file with configuration settings based on the order of relationships of the configuration manger data structure, and establishing settings of a computer device based on the generated configuration file. The methods of FIGS. 7 and 8 are performable by a configuration requester engine and/or a configuration generator engine, such as engines 112 and 114 of FIG. 1B.

At block 702 of FIG. 7, machine information corresponding to a computer device is retrieved. At block 704, data corresponding to a configuration manager data structure is retrieved. The configuration manager data structure has an order of relationships of categories of configuration settings and retrieval of the data of the corresponding configuration manager data structure may be retrieved based on that order.

At block 706, configuration information corresponding to the machine information retrieved at block 702 is identified based on the order of relationships of the configuration manager data structure. At block 708, a configuration file with configurations settings is generated based on the order of relationships of the configuration manager data structure. At block 710, settings of the computer device are established based on the generated configuration file. For example, the settings are applied by settings applicator program executing on a computer device where the settings applicator has plugin capabilities to support future or additional settings. In that example, the settings applicator (and plugins when available) is responsible for updating the device-specific configuration file, use applications or operating system APIs to set the settings as indicated by metadata, update registries, etc.

FIG. 8 includes blocks similar to blocks of FIG. 7 and provides additional blocks and details. In particular, FIG. 8 depicts additional blocks and details generally regarding identifying a computer device, identify a location of the configuration manager data structure, generating the configuration file by overwriting information, and retrieving setting resources. Blocks 804, 808, 810, and 828 are the same as blocks 702, 704, 706, and 710 of FIG. 7 and, for brevity, their respective descriptions are not repeated.

At block 802, a computer device is identified as connected to a network and in a boot state and, at block 804 machine information is retrieved from the computer device identified at block 802. The boot state may trigger identification based on a network event.

At block 806, a location of the configuration manager data structure is identified based on a settings retrieval request. The settings retrieval request may include machine information, such that different groups of computer devices may look to different locations to retrieve data from different copies of configuration manager data structures.

At block 812, the configuration file is generated using an perational flow that overwrites previously retrieved setting when there is a conflict (e.g., duplicate settings exist from different settings categories).

At block 814, the next category in the configuration manager data structure is identified. When the operation initializes, the next category may correspond to the initial element in the configuration manager data structure. At block 816, a determination is made as to whether the category being reviewed is a subcategory (e.g., substring) or a top-level category. In an example, where the implementation includes a retrieval loop, the stopping condition may be reaching a top-level category with the highest priority and the configuration file is ready to be finalized. If the category is a subcategory, setting information is retrieved at block 818. At block 820, a determination is made as to whether a previous setting exists with regards to the setting retrieved at block 818. If not, there is no duplication and the setting may be applied to the final configuration file and the next settings category can be identified at block 814. If a previous setting already exists for the retrieved setting, the setting information is overwritten at block 822 with the information retrieved at block 818. In an example, setting information may be overwritten (or otherwise prepared for insertion into the generated configuration file) based on the order of relationships of the configuration manager data structure (e.g., the order in which the elements are crawled and/or priority identifiers associated with teach element of the configuration manager data structure. Once the entire settings hierarchy of the configuration manager data structure has been traversed, the final configuration file is produced at block 824.

The computer device may retrieve setting resources corresponding to the settings remaining in the configuration file at block 826. This is because the overwriting workflow of the method of FIG. 8 replaces lower priority settings with higher priority settings for duplicate categories, and therefore, the result retrieves resources for the higher priority settings and not for the lower priority duplicate settings. At block 828, the computer device applies the settings of the final configuration file generated at block 812 using the resources retrieved at block 826. The computer device is now ready for operation using the configuration settings appropriate to the particular machine information associated with the computer device. In this manner, settings information may be provided to computer devices with write-protected storage or systems that do not save user session data, including setting configurations, and allow for flexibility for prioritizing groups of settings categories.

Although the flow diagrams of FIGS. 5-8 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present description.

All of the features disclosed in this specification (including any accompanying claims, abstract and drawings), and/or all of the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature that is described as based on some stimulus may be based only on the stimulus or a combination of stimuli including the stimulus. Furthermore, the use of the words “first,” “second,” or related terms in the claims are not used to limit the claim elements to an order or location, but are merely used to distinguish separate claim elements.

The present description has been shown and described with reference to the foregoing examples. It is understood, however, that other forms, details, and examples may be made without departing from the spirit and scope of the following claims.

What is claimed:

1. A service device comprising:
a category manager engine to:
maintain a configuration manager data structure with a plurality of references in an order of category priority, each reference is directed to a category configuration file corresponding to a resource folder for a group of settings;
a priority engine to:
cause the category manager engine to arrange the plurality of references in the order based on parameters including a category identifier and a priority identifier; and
a configuration file request engine to:
provide access to the configuration manager data structure to cause generation of a settings file of configuration settings based on retrieval of resources from resource folders in the order of the plurality of references of the configuration manager data structure.

2. The service device of claim 1, wherein:
the category manager performs an operation to change the position of a reference when the priority identifier is different from a current position of the reference associated with the category identifier.

3. The service device of claim 1, wherein:
the configuration manager data structure is a linked list; and
the order of category priority is changed by changing links between data elements of the linked list.

4. The service device of claim 1, further comprising:
a on-transitory computer-readable storage medium comprising a set of instructions executable by a processor resource to:
receive a priority order request regarding setting category priority for a configuration manager data structure;
arrange a pointer of the configuration manager data structure to a data structure element based on a position identifier of the priority order request;
provide access by a computer device to the configuration manager data structure to retrieve settings via a category configuration file corresponding to the data structure element based on a pointer sequence of the configuration manager data structure, the pointer sequence including the arranged pointer.

5. The service device of claim 4, wherein the set of instructions cause the processor to:
rearrange pointer references corresponding to the order of relationships of categories of configuration settings of the configuration manager data structure based on parameters of a priority order update request.

6. A computer device, comprising:
a configuration requester engine to perform:
a retrieval of system information; and
a retrieval of settings parameters corresponding to the system information based on an order of priority of categories, set by a configuration manager data structure describing a settings hierarchy; and
a configuration generator engine to:
generate a settings configuration file based on an order of retrieval of configuration resources or a priority identifier associated with each retrieval of configuration resources; and
retrieve settings resources corresponding to the configuration resources based on the order of retrieval of configuration resources or the priority identifier associated with each retrieval of configuration resources.

7. The computer device of claim 6, wherein the configuration generator engine:
identifies a duplicate setting category; and
overwrites one of the duplicates of the corresponding configuration setting based on the priority order of the category from which the duplicate setting category was retrieved.

8. The computer device of claim 7, wherein the configuration generator engine:
checks if the category is a substring category;
downloads a settings parameter from a settings data store corresponding to the substring; and
merges the settings parameter into the configuration file when a previous setting existed.

9. The computer device of claim 8, wherein the configuration generator engine:
produces a final category setting when the category is not a substring category; and
cause the computer device to download resources from a resource data store corresponding to the settings configuration file of the final category setting,
wherein the settings configuration the is built based on a sequence of pointers to configuration resources.

10. The computer device of claim 6, wherein:
the configuration requestor engine tracks a subcategory level corresponding to a category configuration file; and
the configuration generator engine merges the settings of the category configuration file with previously retrieved setting when a previous setting existed.

11. The computer device of claim 6, wherein:
the configuration requestor engine tracks a subcategory level corresponding to a category configuration file of the pointer sequence; and
the configuration generator engine merges the settings of the category configuration file with a previously retrieved settings parameter when the subcategory level indicates a priority over a subcategory level of a previous category configuration file corresponding to the previously retrieved setting.

12. The computer device of claim 6, wherein the configuration requestor engine:
triggers a settings retrieval request based on identification of a service available on a network; and
retrieves system information of the computer device corresponding to a number of settings categories.

13. A method of generating a configuration file, the method comprising:
retrieving machine information corresponding to a computer device;
retrieving data of a configuration manager data structure having an order of relationships of categories of configuration settings;
identifying configuration information corresponding to the machine information based on the order of relationships of the configuration manager data structure;
generating the configuration file with configurations settings based on the order of relationships of the configuration manager data structure; and
establishing settings of the computer device based on the generated configuration file.

14. The method of claim 13, comprising:
overwriting information of the generated configuration file based on the order of relationships of the configuration manager data structure; and
retrieving setting resources corresponding to settings remaining in the configuration file.

15. The method of claim 13, comprising:
identifying the computer device is connected to a network and is in a boot state; and
identifying a location of the configuration manager data structure based on a settings retrieval request.
